(19) United States
(12) Patent Application Publication
(10) Pub. No.: US 2026/0265857 A1
(43) Pub. Date: Sep. 10, 2026

(54) METHODS EMPLOYING THIOUREA FOR METAL EXTRACTION

(71) Applicant: RZOLV TECHNOLOGIES INC., North Vancouver (CA)

(72) Inventors: Duane NELSON, North Vancouver (CA); Reza KAFAEI, North Vancouver (CA); Hanif JAFARI, North Vancouver (CA)

(21) Appl. No.: 19/660,646

(22) Filed: Apr. 28, 2026

Related U.S. Application Data
(63) Continuation of application No. PCT/CA2025/050723, filed on May 21, 2025.
(60) Provisional application No. 63/650,731, filed on May 22, 2024.

(51) Int. Cl. C22B 3/08; C22B 3/04; C22B 3/20; C22B 11/00

(52) U.S. Cl. CPC C22B 3/08; C22B 3/045; C22B 3/20; C22B 11/04

(57) ABSTRACT

A leaching solution for extracting metal (e.g., silver, gold and/or copper) from an ore. The leaching solution may comprise a complexing agent and an acid water wherein the complexing agent comprises thiourea and the acid comprises sulfamic acid. The leaching solution may comprise an oxidant. The oxidant comprises NBS and/or BCDMH.

### REFERENCE TO RELATED APPLICATIONS

This application is a continuation of PCT application No. PCT/CA2025/050723 having an international filing date of 21 May 2025 which in turn claims priority from, and for the purposes of the United States the benefit under 35 USC 119 in relation to, U.S. patent application No. 63/650,731 filed on 22 May 2024. All of the applications in this paragraph are hereby incorporated herein by reference.

### TECHNICAL FIELD

The present invention relates to hydrometallurgical extraction or leaching of metals such as silver, gold and copper.

### BACKGROUND OF THE INVENTION

Various metals such as silver, gold and copper are commonly extracted from ore (e.g., low grade ore) by leaching using cyanide-based leaching solutions. However, cyanide is considered to be a hazardous compound because of its toxicity.

Various leaching solutions have been proposed to replace cyanide-based leaching solutions. However, these proposed leaching solutions tend to be undesirably expensive and/or ineffective.

Accordingly, there is a general desire for effective, inexpensive, non-toxic leaching solutions to replace cyanide-based leaching solutions.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a mixture dissolvable in water to form a leaching solution for extracting metal from an ore. The mixture may comprise a complexing agent, the complexing agent comprising thiourea and an acid, the acid comprising sulfamic acid.

In some embodiments, for every gram of complexing agent, the mixture comprises between approximately 0.05 grams and 20 grams of the acid. In some embodiments, for every gram of complexing agent, the mixture comprises between approximately 0.5 grams and 1.5 grams of the acid. In some embodiments, for every gram of complexing agent, the mixture comprises approximately 1.0 gram of the acid.

In some embodiments, the mixture comprises an oxidant. In some embodiments, the mixture comprises an oxidant, the oxidant comprising n-Bromosuccinimide (NBS). In some embodiments, the mixture comprises an oxidant, the oxidant comprising 1-Bromo-3-chloro-5,5-dimethylhydantoin (BCDMH). In some embodiments, for every gram of complexing agent, the mixture comprises between approximately 0.025 grams and 10 grams of the oxidant. In some embodiments, for every gram of complexing agent, the mixture comprises between approximately 0.25 grams and 0.75 grams of the oxidant. In some embodiments, for every gram of complexing agent, the mixture comprises approximately 0.5 grams of the oxidant.

In some embodiments, for every gram of complexing agent, the mixture comprises between approximately: 0.67 grams and 1.5 grams of sulfamic acid; and 0.33 grams and 0.75 grams of NBS. In some embodiments, for every gram of complexing agent, the mixture comprises between approximately: 0.67 grams and 1.5 grams of sulfamic acid, 0.167 grams and 0.375 grams of n-Bromosuccinimide (NBS); and 0.167 grams and 0.375 grams of BCDMH. In some embodiments, for every gram of complexing agent, the mixture comprises between approximately: 0.67 grams and 1.5 grams of sulfamic acid; and 0.33 grams and 0.75 grams of BCDMH. In some embodiments, for every gram of complexing agent, the mixture comprises approximately: 1 gram of sulfamic acid; and 0.5 grams of n-Bromosuccinimide (NBS). In some embodiments, for every gram of complexing agent, the mixture comprises approximately: 1 gram of sulfamic acid; 0.25 grams of n-Bromosuccinimide (NBS); and 0.25 grams of BCDMH. In some embodiments, for every gram of complexing agent, the mixture comprises approximately: 1 gram of sulfamic acid; and 0.5 grams of BCDMH.

In some embodiments, the mixture further comprises an ORP controller to increase oxidation-reduction potential (ORP). In some embodiments, the ORP controller comprises potassium peroxymonosulfate. In some embodiments, the ORP controller comprises 2KHSO5·KHSO4·K2SO4. In some embodiments, the ORP controller comprises Oxone™. In some embodiments, the ORP controller comprises sodium metabisulfate. In some embodiments, the ORP controller comprises sodium sulfite. In some embodiments, for every gram of complexing agent, the mixture comprises between approximately 0.001 grams and 5 grams of the ORP controller.

In some embodiments, the mixture further comprises a supplemental acid to reduce pH. In some embodiments, the supplemental acid comprises sulfuric acid. In some embodiments, for every gram of complexing agent, the mixture comprises between approximately 0.05 grams and 20 grams of the supplemental acid.

In some embodiments, the mixture further comprises a stabilizer. In some embodiments, the stabilizer comprises ethylenediaminetetraacetic acid (EDTA). In some embodiments, the stabilizer comprises sodium lignosulfonate. In some embodiments, the stabilizer comprises sodium glycine. In some embodiments, the stabilizer comprises urea. In some embodiments, for every gram of complexing agent, the mixture comprises between approximately 0.001 grams and 5 grams of stabilizer.

Another aspect of the invention provides a method of preparing a leaching solution. The method may comprise forming a solution by dissolving a complexing agent in water, the complexing agent comprising thiourea and dissolving an acid in the water, the acid comprising sulfamic acid.

In some embodiments, for every liter of the water, the method comprises dissolving between approximately 1 gram and 20 grams of the complexing agent. In some embodiments, for every liter of the water, the method comprises dissolving between approximately 1 gram and 20 grams of the acid.

In some embodiments, forming the solution comprises dissolving an oxidant in the water. In some embodiments, the oxidant comprises n-Bromosuccinimide (NBS). In some embodiments, the oxidant comprises 1-Bromo-3-chloro-5,5-dimethylhydantoin (BCDMH). In some embodiments, for every liter of the water, the method comprises dissolving between approximately 0.025 grams and 10 grams of the oxidant.

In some embodiments, for every liter of the water, the method comprises dissolving between approximately: 5 grams and 15 grams of thiourea; 5 grams and 15 grams of sulfamic acid; and 2.5 grams and 7.5 grams of n-Bromosuccinimide (NBS). In some embodiments, for every liter of the water, the method comprises dissolving between approximately: 5 grams and 15 grams of thiourea; 5 grams and 15 grams of sulfamic acid; grams and 3.75 grams of n-Bromosuccinimide (NBS); and 1.25 grams and 3.75 grams of BCDMH. In some embodiments, for every liter of the water, the method comprises dissolving between approximately: 5 grams and 15 grams of thiourea; 5 grams and 15 grams of sulfamic acid; and 2.5 grams and 7.5 grams of BCDMH. In some embodiments, for every liter of the water, the method comprises dissolving approximately: 10 grams of thiourea; 10 grams of sulfamic acid; and 5 grams of n-Bromosuccinimide (NBS). In some embodiments, for every liter of the water, the method comprises dissolving approximately: 10 grams of thiourea; 10 grams of sulfamic acid; 2.5 grams of n-Bromosuccinimide (NBS); and 2.5 grams of BCDMH. In some embodiments, for every liter of the water, the method comprises dissolving approximately: 10 grams of thiourea; 10 grams of sulfamic acid; and 5 grams of BCDMH.

In some embodiments, the method comprises adjusting the oxidation-reduction potential (ORP) of the solution by adding an ORP controller. In some embodiments, the ORP controller ORP controller comprises potassium peroxymonosulfate. In some embodiments, the ORP controller ORP controller comprises 2KHSO5·KHSO4·K2SO4. In some embodiments, the ORP controller ORP controller comprises Oxone™. In some embodiments, the ORP controller ORP controller comprises sodium metabisulfate. In some embodiments, the ORP controller ORP controller comprises sodium sulfite. In some embodiments, for every liter of the water, the method comprises adding between approximately 0.5 grams and 5 grams of the ORP controller to the solution.

In some embodiments, the method comprises adjusting the oxidation-reduction potential (ORP) of the solution by electrochemical oxidation. In some embodiments, adjusting the oxidation-reduction potential (ORP) of the solution by electrochemical oxidation comprises contacting the solution with an anode and a cathode and applying a voltage across the anode and the cathode. In some embodiments, the anode comprises a platinum anode. In some embodiments, the anode comprises a boron-doped diamond anode. In some embodiments, the anode comprises a ruthenium oxide coated anode. In some embodiments, the anode comprises an iridium oxide coated anode. In some embodiments, the cathode comprises an uncoated titanium cathode. In some embodiments, the cathode comprises a graphite cathode. In some embodiments, the voltage is between approximately 0.3V and 30V. In some embodiments, the voltage is between approximately 0.7V and 5V. In some embodiments, the voltage is between approximately 1.5V and 2.5V. In some embodiments, a current density of the cathode is between approximately 10 A/m² and 300 A/m². In some embodiments, a current density of the cathode is between approximately 15 A/m² and 200 A/m². In some embodiments, a current density of the cathode is between approximately 20 A/m² and 150 A/m². In some embodiments, a residence time of the solution in contact with the anode and the cathode is between approximately 2 minutes and 60 minutes. In some embodiments, a residence time of the solution in contact with the anode and the cathode is between approximately 5 minutes and 25 minutes. In some embodiments, a residence time of the solution in contact with the anode and the cathode is between approximately 10 minutes and 15 minutes. In some embodiments, the method comprises adjusting the ORP of the solution to between approximately 150 mV and 450 mV. In some embodiments, the method comprises adjusting the ORP of the solution to between approximately 170 mV and 220 mV. In some embodiments, the method comprises adjusting the ORP of the solution to between approximately 180 mV and 200 mV.

In some embodiments, the method comprises decreasing the pH of the solution. In some embodiments, the method comprises decreasing the pH of the solution by adding supplemental acid to the solution. In some embodiments, the method comprises decreasing the pH of the solution by adding for every liter of the water, between approximately 1 gram and 20 grams of supplemental acid to the solution. In some embodiments, the supplemental acid comprises sulfuric acid. In some embodiments, the method comprises decreasing the pH of the solution to between approximately 0.5 and 2 by adding supplemental acid to the solution. In some embodiments, the method comprises decreasing the pH of the solution to between approximately 1 and 1.5 by adding supplemental acid to the solution. In some embodiments, the method comprises decreasing the pH of the solution to between approximately 1.3 and 1.4 by adding supplemental acid to the solution.

In some embodiments, the method comprises adding a stabilizer to the solution. In some embodiments, the method comprises adding for every liter of the water, between approximately 0.5 grams and 5 grams of a stabilizer to the solution. In some embodiments, the stabilizer comprises ethylenediaminetetraacetic acid (EDTA). In some embodiments, the stabilizer comprises sodium lignosulfonate. In some embodiments, the stabilizer comprises glycine. In some embodiments, the stabilizer comprises urea.

In some embodiments, the method comprises forming a solution by: dissolving the acid in the water after dissolving the complexing agent in the water.

Another aspect of the invention provides a method of forming a leaching solution by dissolving one of the mixtures described herein in water.

In some embodiments, the method comprises adjusting the oxidation-reduction potential (ORP) of the solution by electrochemical oxidation. In some embodiments, adjusting the oxidation-reduction potential (ORP) of the solution by electrochemical oxidation comprises contacting the solution with an anode and a cathode and applying a voltage across the anode and the cathode. In some embodiments, the anode comprises a platinum anode. In some embodiments, the anode comprises a boron-doped diamond anode. In some embodiments, the anode comprises a ruthenium oxide coated anode. In some embodiments, the anode comprises an iridium oxide coated anode. In some embodiments, the cathode comprises an uncoated titanium cathode. In some embodiments, the cathode comprises a graphite cathode. In some embodiments, the voltage is between approximately 0.3V and 30V. In some embodiments, the voltage is between approximately 0.7V and 5V. In some embodiments, the voltage is between approximately 1.5V and 2.5V. In some embodiments, a current density of the cathode is between approximately 10 A/m² and 300 A/m². In some embodiments, a current density of the cathode is between approximately 15 A/m² and 200 A/m². In some embodiments, a current density of the cathode is between approximately 20 A/m² and 150 A/m². In some embodiments, a residence time of the solution in contact with the anode and the cathode is between approximately 2 minutes and 60 minutes. In some embodiments, a residence time of the solution in contact with the anode and the cathode is between approximately 5 minutes and 25 minutes. In some embodiments, a residence time of the solution in contact with the anode and the cathode is between approximately 10 minutes and 15 minutes. In some embodiments, the method comprises adjusting the ORP of the solution to between approximately 150 mV and 450 mV. In some embodiments, the method comprises adjusting the ORP of the solution to between approximately 170 mV and 220 mV. In some embodiments, the method comprises adjusting the ORP of the solution to between approximately 180 mV and 200 mV.

Another aspect of the invention provides a leaching solution comprising water, a complexing agent dissolved in the water, the complexing agent comprising thiourea and an acid dissolved in the water, the acid comprising sulfamic acid.

In some embodiments, the leaching solution comprises for every liter of the water, between approximately 1 gram and 20 grams of the complexing agent. In some embodiments, the leaching solution comprises for every liter of the water, between approximately 1 gram and 20 grams of the acid.

In some embodiments, the leaching solution comprises an oxidant dissolved in the water. In some embodiments, the oxidant comprises n-Bromosuccinimide (NBS). In some embodiments, the oxidant comprises 1-Bromo-3-chloro-5,5-dimethylhydantoin (BCDMH). In some embodiments, the leaching solution comprises for every liter of the water, between approximately 0.025 grams and 10 grams of the oxidant.

In some embodiments, the leaching solution comprises for every liter of the water, between approximately: 5 grams and 15 grams of thiourea; 5 grams and 15 grams of sulfamic acid; and 2.5 grams and 7.5 grams of n-Bromosuccinimide (NBS). In some embodiments, the leaching solution comprises for every liter of the water, between approximately: 5 grams and 15 grams of thiourea; 5 grams and 15 grams of sulfamic acid; 1.25 grams and 3.75 grams of n-Bromosuccinimide (NBS); and 1.25 grams and 3.75 grams of BCDMH. In some embodiments, the leaching solution comprises for every liter of the water, between approximately: 5 grams and 15 grams of thiourea; 5 grams and 15 grams of sulfamic acid; and 2.5 grams and 7.5 grams of BCDMH. In some embodiments, the leaching solution comprises for every liter of the water, approximately: 10 grams of thiourea; 10 grams of sulfamic acid; and 5 grams of n-Bromosuccinimide (NBS). In some embodiments, the leaching solution comprises for every liter of the water, approximately: 10 grams of thiourea; 10 grams of sulfamic acid; 2.5 grams of n-Bromosuccinimide (NBS); and 2.5 grams of BCDMH. In some embodiments, the leaching solution comprises for every liter of the water, approximately: 10 grams of thiourea; 10 grams of sulfamic acid; and 5 grams of BCDMH.

In some embodiments, the leaching solution comprises an ORP controller dissolved in the water. In some embodiments, the ORP controller ORP controller comprises potassium peroxymonosulfate. In some embodiments, the ORP controller ORP controller comprises 2KHSO5·KHSO4·K2SO4. In some embodiments, the ORP controller ORP controller comprises Oxone™. In some embodiments, the ORP controller ORP controller comprises sodium metabisulfate. In some embodiments, the ORP controller ORP controller comprises sodium sulfite. In some embodiments, the leaching solution comprises for every liter of the water, between approximately 0.5 grams and 5 grams of the ORP controller. In some embodiments, the ORP of the leaching solution is between approximately 150 mV and 450 mV. In some embodiments, the ORP of the leaching solution is between approximately 170 mV and 220 mV. In some embodiments, the ORP of the leaching solution is between approximately 180 mV and 200 mV.

In some embodiments, the leaching solution comprises a supplemental acid dissolved in the water. In some embodiments, the leaching solution comprises for every liter of the water, between approximately 1 gram and 20 grams of the supplemental acid. In some embodiments, the supplemental acid comprises sulfuric acid. In some embodiments, the pH of the leaching solution is between approximately 0.5 and 2. In some embodiments, the pH of the solution is between approximately 1 and 1.5. In some embodiments, the pH of the solution is between approximately 1.3 and 1.4 by adding supplemental acid to the solution.

In some embodiments, the leaching solution comprises a stabilizer dissolved in the water. In some embodiments, the leaching solution comprises for every liter of the water, between approximately 0.5 grams and 5 grams of a stabilizer. In some embodiments, the stabilizer comprises ethylenediaminetetraacetic acid (EDTA). In some embodiments, the stabilizer comprises sodium lignosulfonate. In some embodiments, the stabilizer comprises glycine. In some embodiments, the stabilizer comprises urea.

Another aspect of the invention provides a method of extracting metal from an ore. The method may comprises obtaining a leaching solution as described herein or according to the methods described herein, contacting the leaching solution with the ore to dissolve the metal thereby forming a leachate and separating the leachate from the ore. In some embodiments, the metal comprises gold. In some embodiments, the metal comprises copper. In some embodiments, the metal comprises silver.

In some embodiments the method further comprises collecting the metal from the leachate by adsorption onto activated carbon. In some embodiments, the method further comprises collecting the metal from the leachate by ion exchange. In some embodiments, the method further comprises collecting the metal from the leachate by solvent extraction. In some embodiments, the method further comprises collecting the metal from the leachate by precipitation. In some embodiments, contacting the leaching solution with the ore comprises heap leaching.

In some embodiments, the method further comprises recycling the leachate after collecting the metal from the leachate to thereby produce recycled leaching solution. In some embodiments, recycling the leachate comprises adjusting the oxidation-reduction potential (ORP) of the leachate by electrochemical oxidation to thereby produce the recycled leaching solution. In some embodiments, adjusting the ORP of the leachate by electrochemical oxidation comprises contacting the leachate with an anode and a cathode and applying a voltage across the anode and the cathode. In some embodiments, the anode comprises a platinum anode. In some embodiments, the anode comprises a boron-doped diamond anode. In some embodiments, the anode comprises a ruthenium oxide coated anode. In some embodiments, the anode comprises an iridium oxide coated anode. In some embodiments, the cathode comprises an uncoated titanium cathode. In some embodiments, the cathode comprises a graphite cathode. In some embodiments, the voltage is between approximately 0.3V and 30V. In some embodiments, the voltage is between approximately 0.7V and 5V. In some embodiments, the voltage is between approximately 1.5V and 2.5V. In some embodiments, a current density of the cathode is between approximately 10 A/m² and 300 A/m². In some embodiments, a current density of the cathode is between approximately 15 A/m² and 200 A/m². In some embodiments, a current density of the cathode is between approximately 20 A/m² and 150 A/m². In some embodiments, a residence time of the leachate in contact with the anode and the cathode is between approximately 2 minutes and 60 minutes. In some embodiments, a residence time of the leachate in contact with the anode and the cathode is between approximately 5 minutes and 25 minutes. In some embodiments, a residence time of the leachate in contact with the anode and the cathode is between approximately 10 minutes and 15 minutes.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a schematic diagram of a mixture dissolvable in water to form a leaching solution for extracting metal from an ore according to an example embodiment of the invention.

FIG. 2 depicts a method for preparing a leaching solution for extracting metal from an ore according to an example embodiment of the invention.

FIG. 3 depicts another method for preparing a leaching solution for extracting metal from an ore according to an example embodiment of the invention.

FIG. 4 depicts a leaching solution for extracting metal from an order according to an example embodiment of the invention.

FIG. 5 depicts a method of extracting metal from an ore according to an example embodiment of the invention.

FIG. 6 depicts a plot of the efficacy of an embodiment of the leaching solution disclosed herein as compared to a cyanide-based leaching solution.

### DETAILED DESCRIPTION OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides a mixture dissolvable in water to form a leaching solution employable for leaching of metal (e.g., silver, gold and/or copper) from an ore. The mixture may comprise a complexing agent such as thiourea and an acid such as sulfamic acid. The mixture may comprise an oxidant such as n-Bromosuccinimide (NBS) and/or 1-Bromo-3-chloro-5,5-dimethylhydantoin (BCDMH).

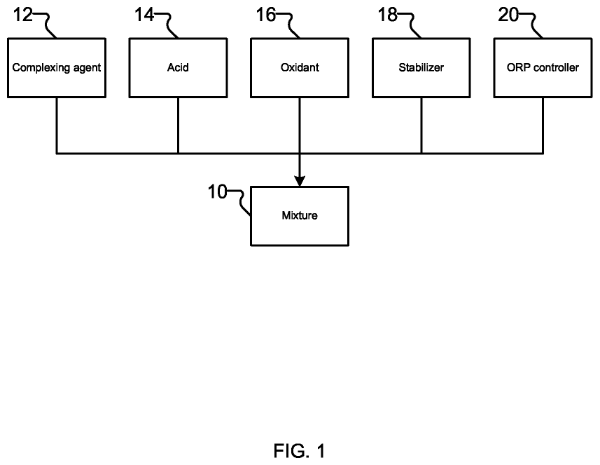

FIG. 1 depicts a mixture 10 dissolvable in water to form a leaching solution employable for leaching of metal (e.g., silver, gold and/or copper) from an ore according to an example embodiment of the invention. Mixture 10 may be stored and transported in an undiluted solid phase. Then, prior to use, mixture 10 may be mixed with water to form a leaching solution, as discussed further herein. Since mixture 10 may be transported and stored in an undiluted solid form (e.g., without water) and then mixed with water onsite, storing and/or transport costs may be reduced as compared to traditional leaching solutions which are stored and/or transported in a diluted liquid form.

Mixture 10 comprises a complexing agent 12 and an acid 14. Complexing agent 12 may comprise thiourea. Acid 14 may comprise sulfamic acid.

Mixture 10 may comprise, for every 1.0 gram of complexing agent 12, between approximately 0.05 grams and 20.0 grams of acid 14. In some embodiments, mixture 10 comprises, for every 1.0 gram of complexing agent 12, between approximately 0.5 grams and 1.5 grams of acid 14. In some embodiments, mixture 10 comprises, for every 1.0 gram of complexing agent 12, approximately 1.0 gram of acid 14.

Mixture 10 may optionally comprise an oxidant 16. Oxidant 16 may comprise NBS and/or BCDMH.

Mixture 10 may comprise, for every 1.0 gram of complexing agent 12, between approximately 0.025 grams and 10.0 grams of oxidant 16. In some embodiments, mixture 10 comprises, for every 1.0 gram of complexing agent 12, between approximately 0.25 grams and 0.75 grams of oxidant 16. In some embodiments, mixture 10 comprises, for every 1.0 gram of complexing agent 12, approximately 0.5 grams of oxidant 16.

In some embodiments, mixture 10 comprises thiourea as complexing agent 12, sulfamic acid as acid 14 and NBS as oxidant 16. In some embodiments, mixture 10 comprises for every 1.0 gram of thiourea, between approximately 0.5 grams and 1.5 grams of sulfamic acid and between approximately 0.25 grams and 0.75 grams of NBS. In some embodiments, mixture 10 comprises for every 1.0 gram of thiourea, approximately 1.0 gram of sulfamic acid and 0.5 grams of NBS.

In some embodiments, mixture 10 comprises thiourea as complexing agent 12, sulfamic acid as acid 14 and BCDMH as oxidant 16. In some embodiments, mixture 10 comprises for every 1.0 gram of thiourea, between approximately 0.5 grams and 1.5 grams of sulfamic acid and between approximately 0.25 grams and 0.75 grams of BCDMH. In some embodiments, mixture 10 comprises for every 1.0 gram of thiourea, approximately 1.0 gram of sulfamic acid and 0.5 grams of BCDMH.

In some embodiments, mixture 10 comprises thiourea as complexing agent 12, sulfamic acid as acid 14, and NBS and BCDMH as oxidants 16. In some embodiments, mixture 10 comprises for every 1.0 gram of thiourea, between approximately 0.5 grams and 1.5 grams of sulfamic acid, between approximately 0.125 grams and 0.375 grams of BCDMH and between approximately 0.125 grams and 0.375 grams of NBS. In some embodiments, mixture 10 comprises for every 1.0 gram of thiourea, approximately 1.0 gram of sulfamic acid, 0.25 grams of BCDMH and 0.25 grams of NBS.

In some embodiments, mixture 10 further comprises a stabilizer 18. Stabilizer 18 may comprise one or more of ethylenediaminetetraacetic acid (EDTA), urea, sodium lignosulfonate and glycine. Mixture 10 may comprise, for every 1.0 gram of complexing agent 12, between approximately 0.01 grams and 5.0 grams of stabilizer 18.

In some embodiments, mixture 10 further comprises an ORP controller 20. ORP controller 20 may comprise one or more of sodium metabisulfate and sodium sulfate. In some embodiments, ORP controller 20 comprises one or more of potassium peroxymonosulfate and the triple salt 2KHSO5·KHSO4·K2SO4 of potassium peroxymonosulfate (available commercially under the name Oxone™).

Mixture 10 may comprise, for every 1.0 gram of complexing agent 12, between approximately 0.01 grams and 5.0 grams of ORP controller 20. In some embodiments, ORP controller 20 is not present in mixture 10 but is instead added after mixture 10 is dissolved in water to achieve a leaching solution with a desired ORP, as described further herein.

Another aspect of the invention provides a method for preparing a leaching solution for extracting metal (e.g., silver, gold and/or copper) from an ore. The method may comprise dissolving a mixture in water wherein the mixture comprises a complexing agent such as thiourea, an acid such as sulfamic acid. In some embodiments, the mixture comprises an oxidant. The method may comprise adjusting a pH by adding an acid. The method may comprise adjusting the ORP by adding an ORP controller and/or by electrochemical oxidation.

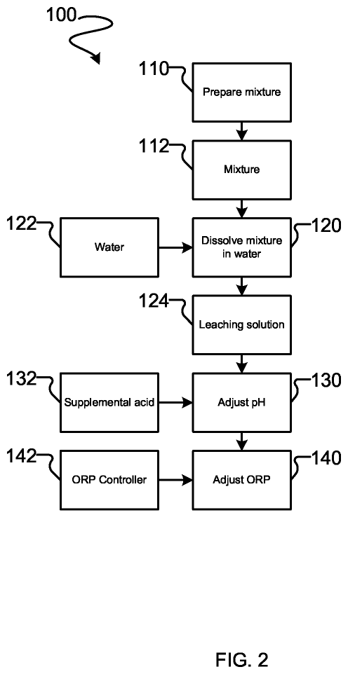

FIG. 2 depicts a method 100 for preparing a leaching solution 124 for extracting metal (e.g., silver, gold and/or copper) from an ore according to example embodiment of the invention.

Block 110 may comprise preparing a mixture 112. Mixture 112 may comprise a complexing agent such as thiourea and an acid such as sulfamic acid. Mixture 112 may comprise an oxidant such as NBS and/or BCDMH. Mixture 112 may comprise mixture 10 discussed herein. For convenience, method 100 is described herein for the case where mixture 112 comprises mixture 10.

Block 120 of method 100 comprises dissolving mixture 112 in water 122 to form leaching solution 124. To facilitate and/or expedite dissolution of mixture 112, block 120 may comprise agitating or actively mixing mixture 112 in water 122.

Mixture 112 may be dissolved in water 122 to achieve a concentration of between approximately 1 gram and 20 grams of complexing agent 12 per liter of water 122. Mixture 112 may be dissolved in water 122 to achieve a concentration of between approximately 5 grams and 15 grams of complexing agent 12 per liter of water 122. Mixture 112 may be dissolved in water 122 to achieve a concentration of approximately 10 grams of complexing agent 12 per liter of water 122.

To achieve the desired pH of leaching solution 124, method 100 may comprise an optional block 130. Optional block 130 may comprise adjusting the pH of leaching solution 124. Adjusting the pH of leaching solution 124 may comprise adding a supplementary acid 132 to leaching solution 124 to lower the pH. Supplementary acid 132 may comprise sulfamic acid and/or sulfuric acid. In some embodiments, block 130 comprises adding supplementary acid 132 to leaching solution 124 until the desired pH is achieved.

In some embodiments, a desired pH of leaching solution 124 is between approximately 0.5 and 2.0. In some embodiments, a desired pH of leaching solution 124 is between approximately 1.0 and 1.5. In some embodiments, a desired pH of leaching solution 124 is between approximately 1.3 and 1.4.

To achieve the desired ORP of leaching solution 124, method 100 may comprise an optional block 140. Optional block 140 may comprise adjusting the ORP of leaching solution 124.

Adjusting the ORP of leaching solution 124 at block 140 may comprise adding an ORP controller 142 to leaching solution 124 to increase or decrease the ORP. ORP controller 142 may comprise potassium peroxymonosulfate. In some embodiments, ORP controller 142 comprises the triple salt 2KHSO5·KHSO4·K2SO4 of potassium peroxymonosulfate (available commercially under the name Oxone™). In some embodiments, ORP controller 142 comprises one or more of sodium metabisulfate and sodium sulfate. In some embodiments, block 140 comprises adding ORP controller 142 to leaching solution 124 until the desired ORP is achieved.

Adjusting the ORP of leaching solution 124 at block 140 may employ electrochemical oxidation of leaching solution 124. Electrochemical oxidation may be employed to generate reactive thiourea oxidation species in leaching solution 124. Electrochemical oxidation may facilitate achieving a desired ORP of leaching solution 124 without (or with a reduced reliance on) chemical oxidants (e.g., oxidant 16, ORP controller 142 or the like).

Block 140 may employ an electrochemical cell to achieve a desired ORP of leaching solution 124. The electrochemical cell may be a batch cell or a continuous flow cell. The electrochemical cell may comprise an anode and a cathode for passing current through leaching solution 124. The anode may comprise, for example, a platinum anode, a boron-doped diamond anode, a ruthenium oxide coated anode (e.g., coated on titanium) or an iridium oxide coated anode (e.g., coated on titanium). The cathode may comprise, for example, an uncoated titanium cathode or a graphite cathode. The voltage applied across the anode and the cathode may be between approximately 0.3 V and 30 V. The voltage applied across the anode and the cathode may be between approximately 0.7 V and 5 V. The voltage applied across the anode and the cathode may be between approximately 1.5 V and 2.5 V. The current density may be between approximately 10 A/m² and 300 A/m². The current density may be between approximately 15 A/m² and 200 A/m². The current density may be between approximately 20 A/m² and 150 A/m². The temperature of leaching solution 124 at block 140 may be ambient temperature. For example, the temperature may be between approximately 10° C. and 40° C., between approximately 15° C. and 35° C. or between approximately 20° C. and 25° C. The residence time of leaching solution 124 in the electrochemical cell may be between approximately 2 minutes and 60 minutes, between approximately 5 minutes and 25 minutes or between approximately 10 minutes and 15 minutes.

In some embodiments, adjusting the ORP of leaching solution 124 at block 140 may comprise a combination of adding ORP controller 142 and electrochemical oxidation.

In some embodiments, a desired oxidation reduction potential (ORP) of leaching solution 124 is between approximately 150 mV and 450 mV (all ORP values described herein are with reference to a silver/silver chloride electrode). In some embodiments, a desired ORP of leaching solution 124 is between approximately 170 mV and 220 mV. In some embodiments, a desired pH of leaching solution 124 is between approximately 180 mV and 200 mV.

Another aspect of the invention provides a method of preparing a leaching solution for extracting metal (e.g., silver, gold and/or copper) from an ore. The method may comprise dissolving a complexing agent in water and dissolving an acid in the water wherein the complexing agent comprises thiourea and the acid comprises sulfamic acid.

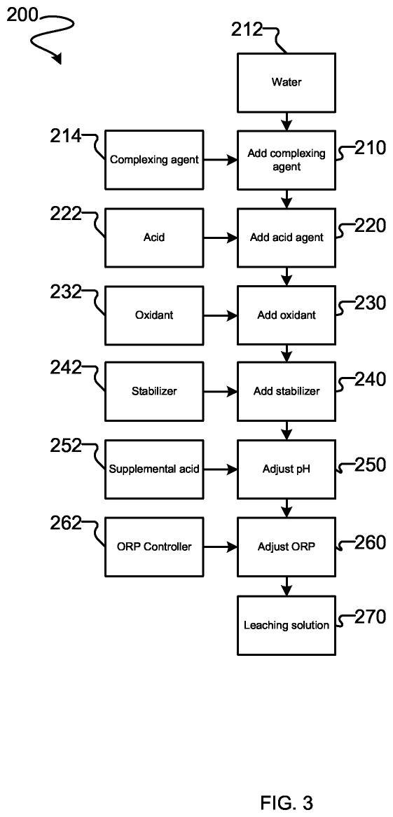

FIG. 3 depicts a method 200 of preparing a leaching solution 270 for extracting metal (e.g., silver, gold and/or copper) from an ore according to example embodiment of the invention.

At block 210, a complexing agent 214 is added to water 212. Complexing agent 214 may comprise thiourea. In some embodiments, adding complexing agent 214 to water 212 comprises dissolving complexing agent 214 in water 212. Block 210 may comprise agitation or active mixing.

In some embodiments, between approximately 1 gram and 20 grams of complexing agent 214 is added per liter of water 212 at block 210. In some embodiments, between approximately 5 grams and 15 grams of complexing agent 214 is added per liter of water 212 at block 210. In some embodiments, approximately 10 grams of complexing agent 214 is added per liter of water 212 at block 210.

At block 220, an acid 222 is added to water 212. Acid 222 may comprise sulfamic acid. In some embodiments, adding acid 222 to water 212 comprises dissolving acid 222 in water 212. Block 220 may comprise agitation or active mixing.

In some embodiments, between approximately 1 gram and 20 grams of acid 222 is added per liter of water 212 at block 220. In some embodiments, between approximately 5 grams and 15 grams of acid 222 is added per liter of water 212 at block 220. In some embodiments, approximately 10 grams of acid 222 is added per liter of water 212 at block 220.

At block 230, an oxidant 232 may optionally be added to water 212. Oxidant 232 may comprise NBS and/or BCDMH. In some embodiments, adding oxidant 232 to water 212 comprises dissolving oxidant 232 in water 212. Block 230 may comprise agitation or active mixing.

In some embodiments, between approximately 0.1 grams and 20 grams of oxidant 232 is added per liter of water 212 at block 230. In some embodiments, between approximately 2.5 grams and 7.5 grams of oxidant 232 is added per liter of water 212 at block 230. In some embodiments, approximately 5 grams of oxidant 232 is added per liter of water 212 at block 230.

At optional block 240, a stabilizer 242 may be added to water 212. Stabilizer 242 may comprise one or more of EDTA, urea, sodium lignosulfonate and glycine. In some embodiments, adding stabilizer 242 to water 212 comprises dissolving stabilizer 242 in water 212. Block 240 may comprise agitation or active mixing.

In some embodiments, between approximately 0.1 grams and 50 grams of stabilizer 242 is added per liter of water 212 at block 240. In some embodiments, between approximately 0.25 grams and 20 grams of stabilizer 242 is added per liter of water 212 at block 240. In some embodiments, between approximately 0.5 grams and 5 grams of stabilizer 242 is added per liter of water 212 at block 240.

At optional block 250, the pH may be adjusted. In some embodiments, the pH may be reduced by adding a supplemental acid 252 at optional block 250. Supplemental acid 252 may comprise sulfamic acid and/or sulfuric acid. Where supplemental acid 252 is a solid, block 250 may comprise dissolving supplemental acid 252 in water 212. Block 250 may comprise agitation or active mixing.

In some embodiments, between approximately 1 gram and 20 grams of supplemental acid 252 is added per liter of water 212 at block 250.

In some embodiments, supplemental acid 252 is added until a desired pH is achieved. In some embodiments, a desired pH of leaching solution 270 is between approximately 0.5 and 2.0. In some embodiments, a desired pH of leaching solution 270 is between approximately 1.0 and 1.5. In some embodiments, a desired pH of leaching solution 270 is between approximately 1.3 and 1.4.

At optional block 260, the ORP may be adjusted. In some embodiments, the ORP is increased or decreased by adding an ORP controller 262 to water 212 at optional block 260. ORP controller 262 may comprise potassium peroxymonosulfate. In some embodiments, ORP controller 262 comprises the triple salt 2KHSO5·KHSO4·K2SO4 of potassium peroxymonosulfate (available commercially under the name Oxone™). In some embodiments, ORP controller 262 to comprises one or more of sodium metabisulfate and sodium sulfite. In some embodiments, adding ORP controller 262 to water 212 comprises dissolving ORP controller 262 in water 212. Block 260 may comprise agitation or active mixing.

In some embodiments, between approximately 0.5 grams and 5 grams of ORP controller 262 is added per liter of water 212 at block 260.

Adjusting the ORP of leaching solution 270 at block 260 may employ electrochemical oxidation of leaching solution 270. Electrochemical oxidation may be employed to generate reactive thiourea oxidation species in leaching solution 270. Electrochemical oxidation may facilitate achieving a desired ORP of leaching solution 270 without (or with a reduced reliance on) chemical oxidants (e.g., oxidant 232, ORP controller 262 or the like).

Block 260 may employ an electrochemical cell to achieve a desired ORP of leaching solution 270. The electrochemical cell may be a batch cell or a continuous flow cell. The electrochemical cell may comprise an anode and a cathode for passing current through leaching solution 270. The anode may comprise, for example, a platinum anode, a boron-doped diamond anode, a ruthenium oxide coated anode (e.g., coated on titanium) or an iridium oxide coated anode (e.g., coated on titanium). The cathode may comprise, for example, an uncoated titanium cathode or a graphite cathode. The voltage applied across the anode and the cathode may be between approximately 0.3 V and 30 V. The voltage applied across the anode and the cathode may be between approximately 0.7 V and 5 V. The voltage applied across the anode and the cathode may be between approximately 1.5 V and 2.5 V. The current density may be between approximately 10 A/m² and 300 A/m². The current density may be between approximately 15 A/m² and 200 A/m². The current density may be between approximately 20 A/m² and 150 A/m². The temperature of leaching solution 270 at block 260 may be ambient temperature. For example, the temperature may be between approximately 10° C. and 40° C., between approximately 15° C. and 35° C. or between approximately 20° C. and 25° C. The residence time of leaching solution 270 in the electrochemical cell may be between approximately 2 minutes and 60 minutes, between approximately 5 minutes and 25 minutes or between approximately 10 minutes and 15 minutes.

In some embodiments, adjusting the ORP of leaching solution 270 at block 260 may comprise a combination of adding ORP controller 262 and electrochemical oxidation.

In some embodiments, a desired ORP of leaching solution 270 is between approximately 150 mV and 450 mV. In some embodiments, a desired ORP of leaching solution 270 is between approximately 170 mV and 220 mV. In some embodiments, a desired pH of leaching solution 270 is between approximately 180 mV and 200 mV.

In some embodiments, one or more of blocks 210, 220, 230, 240, 250 and 260 occur in series. In some embodiments, one or more of blocks 210, 220, 230, 240, 250 and 260 occur in parallel. In some embodiments, block 220 occurs after block 210 and block 230 occurs after block 220.

Another aspect of the invention provides a leaching solution for extracting metal (e.g., silver, gold and/or copper) from an ore. The leaching solution may comprise a complexing agent and an acid water wherein the complexing agent comprises thiourea and the acid comprises sulfamic acid. The leaching solution may comprise an oxidant wherein the oxidant comprises NBS and/or BCDMH.

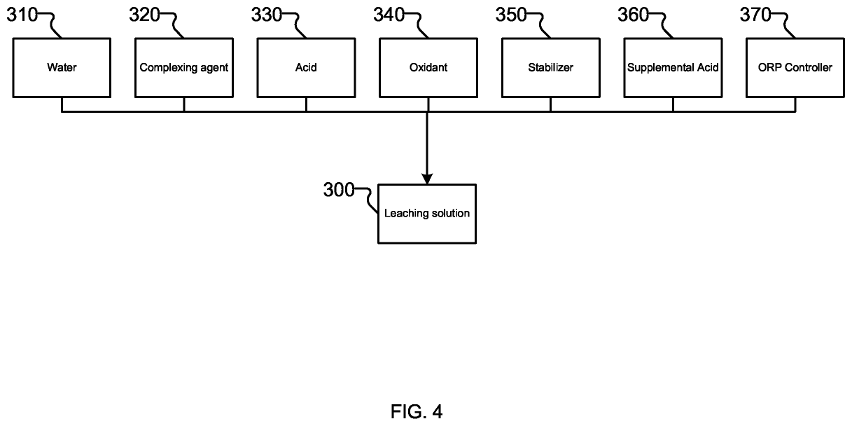

FIG. 4 depicts a leaching solution 300 for extracting metal (e.g., silver, gold and/or copper) from an ore according to example embodiment of the invention. Leaching solution 300 comprises water 310.

Leaching solution 300 comprises a complexing agent 320. Complexing agent 320 may comprise thiourea. In some embodiments, leaching solution 300 comprises between approximately 1 gram and 20 grams of complexing agent 320 per liter of water 310. In some embodiments, leaching solution 300 comprises between approximately 5 grams and 15 grams of complexing agent 320 per liter of water 310. In some embodiments, leaching solution 300 comprises between approximately 10 grams of complexing agent 320 per liter of water 310.

Leaching solution 300 comprises an acid 330. Acid 330 may comprise sulfamic acid. In some embodiments, leaching solution 300 comprises between approximately 1 gram and 20 grams of acid 330 per liter of water 310. In some embodiments, leaching solution 300 comprises between approximately 5 grams and 15 grams of acid 330 per liter of water 310. In some embodiments, leaching solution 300 comprises approximately 10 grams of acid 330 per liter of water 310.

Leaching solution 300 may comprise an oxidant 340. Oxidant 340 may comprise NBS and/or BCDMH. In some embodiments, leaching solution 300 comprises between approximately 0.1 grams and 20 grams of oxidant 340 per liter of water 310. In some embodiments, leaching solution 300 comprises between approximately 2.5 grams and 7.5 grams of oxidant 340 per liter of water 310. In some embodiments, leaching solution 300 comprises approximately 5 grams of oxidant 340 per liter of water 310.

Leaching solution 300 may comprise a stabilizer 350. Stabilizer 350 may comprise one or more of EDTA, urea, sodium lignosulfonate and glycine. In some embodiments, leaching solution 300 comprises between approximately 0.1 grams and 50 grams of stabilizer 350 per liter of water 310. In some embodiments, leaching solution 300 comprises between approximately 0.25 grams and 20 grams of stabilizer 350 per liter of water 310. In some embodiments, leaching solution 300 comprises between approximately 0.5 grams and 5 grams of stabilizer 350 per liter of water 310.

Leaching solution 300 may comprise a supplemental acid 360. Supplemental acid 360 may comprise sulfamic acid and/or sulfuric acid. In some embodiments, leaching solution 300 comprises between approximately 1 gram and 20 grams of supplemental acid 360 per liter of water 310.

Leaching solution 300 may have a pH between approximately 1.0 and 1.5. Leaching solution 300 may have a pH between approximately 1.3 and 1.4.

Leaching solution 300 may comprise an ORP controller 370. ORP controller 370 may comprise potassium peroxymonosulfate. In some embodiments, ORP controller 370 comprises the triple salt 2KHSO5·KHSO4·K2SO4 of potassium peroxymonosulfate (available commercially under the name Oxone™). In some embodiments, ORP controller 370 comprises one or more of sodium metabisulfate and sodium sulfite. In some embodiments, leaching solution 300 comprises between approximately 0.5 grams and 5 grams of ORP controller 370 per liter of water 310.

In some embodiments, leaching solution 300 has an ORP between approximately 150 mV and 450 mV. In some embodiments, leaching solution 300 has an ORP between approximately 170 mV and 220 mV. In some embodiments, leaching solution 300 has an ORP between approximately 180 mV and 200 mV.

Another aspect of the invention provides a method of extracting metal (e.g., silver, gold and/or copper) from an ore. The method may comprise obtaining a leaching solution, contacting the leaching solution with the ore to dissolve the metals thereby forming a leachate and then separating the leachate from the ore.

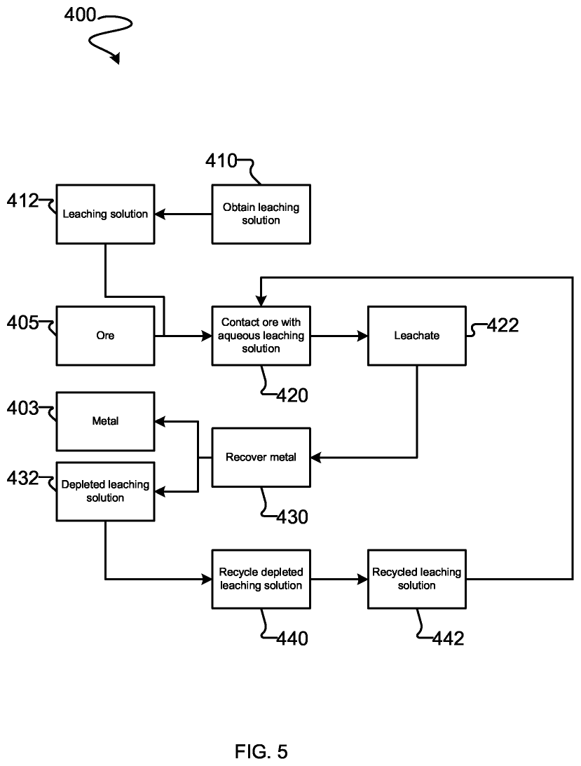

FIG. 5 depicts a method 400 of extracting metal 403 (e.g., silver, gold and/or copper) from an ore 405 according to an example embodiment of the invention.

Block 410 of method 400 comprises obtaining a leaching solution 412. Leaching solution 412 may comprise leaching solution 300. Leaching solution 412 may be a leaching solution obtained, for example according to method 100 or method 200 described herein.

At block 420, leaching solution 412 is caused to contact ore 405. Ore 405 may be a metal bearing ore such as a silver, gold and/or copper-bearing ore. As with cyanide leaching treatments, ore 405 may be processed prior to block 420. For example, ore 405 may be subject to crushing, grinding, separating, agglomeration or the like prior to block 420.

Contacting ore 405 with leaching solution 412 at block 420 may comprise leaching such as, for example, heap leaching, dump leaching, in situ leaching, vat leaching or tank leaching. For example, where block 420 comprises heap leaching, ore 405 may be stacked on a heap pad or leach pad and leaching solution 412 may be applied to the top of the heap by sprinklers, a drip irrigation system, or the like. Leachate 422 comprised of metal 403 dissolved in leaching solution 412 drains to the bottom of the heap and may be collected in, for example, a channel or a pond. Similarly, where block 420 comprises vat leaching, ore 405 is placed in large vat or tank along with leaching solution 412 and, after a period of time, leachate 422 is drained from the vat or tank.

Ore 405 may then be rinsed with water (e.g., spring water, filtered water and/or collected rain water) to collect remaining leachate 422. The rinse-water may then be processed with leachate 422 as discussed further herein. Alternatively, the rinse-water may be processed separately from leachate 422 to recover metal 403 from therefrom. Where processed separately, the rinse-water may be processed in analogous manner to blocks 430 and/or 440.

At block 430, collected leachate 422 is processed to recover metal 403 therefrom. Block 430 may employ traditional recovery methods such as those commonly employed in cyanide leaching treatments. For example, block 430 may employ electro-winning, adsorption onto activated carbon, ion exchange, solvent extraction and/or precipitation.

At block 440, depleted leaching solution 432 output from block 430 may be recycled. Block 440 may comprise by any suitable method to output recycled leaching solution 442. Block 440 may comprise adding one or more of complexing agent 12, acid 14, oxidant 16, stabilizer 18, ORP controller 20 and supplemental acid to depleted leaching solution 442. Block 440 may comprise adjusting the pH of depleted leaching solution 432 in a manner substantially similar to block 130 of method 100. Block 440 may comprise adjusting the ORP of depleted leaching solution 432 in a manner similar to block 140 of method 100 or block 260 of method 200. Recycled leaching solution 442 may then be used in addition to (or in the alternative to) leaching solution 412 at block 420 in future iterations of method 400. In this way, method 400 may continue with minimal loss of leaching solution 412.

Adjusting the ORP of depleted leaching solution 432 at block 440 may employ electrochemical oxidation of depleted leaching solution 432. Electrochemical oxidation may be employed to generate reactive thiourea oxidation species in depleted leaching solution 432. Electrochemical oxidation may facilitate achieving a desired ORP of depleted leaching solution 432 without (or with a reduced reliance on) chemical oxidants (e.g., oxidant 16, ORP controller 20 or the like).

Block 440 may employ an electrochemical cell to achieve a desired ORP of depleted leaching solution 432. The electrochemical cell may be a batch cell or a continuous flow cell. The electrochemical cell may comprise an anode and a cathode for passing current through depleted leaching solution 432. The anode may comprise, for example, a platinum anode, a boron-doped diamond anode, a ruthenium oxide coated anode (e.g., coated on titanium) or an iridium oxide coated anode (e.g., coated on titanium). The cathode may comprise, for example, an uncoated titanium cathode or a graphite cathode. The voltage applied across the anode and the cathode may be between approximately 0.3 V and 30 V. The voltage applied across the anode and the cathode may be between approximately 0.7 V and 5 V. The voltage applied across the anode and the cathode may be between approximately 1.5 V and 2.5 V. The current density may be between approximately 10 A/m² and 300 A/m². The current density may be between approximately 15 A/m² and 200 A/m². The current density may be between approximately 20 A/m² and 150 A/m². The temperature of depleted leaching solution 432 at block 440 may be ambient temperature. For example, the temperature may be between approximately 10° C. and 40° C., between approximately 15° C. and 35° C. or between approximately 20° C. and 25° C. The residence time of depleted leaching solution 432 in the electrochemical cell may be between approximately 2 minutes and 60 minutes, between approximately 5 minutes and 25 minutes or between approximately 10 minutes and 15 minutes.

The invention will now be described with reference to specific examples. It will be understood that the following examples are intended to describe embodiments of the invention and are not intended to limit the invention in any way. It will be understood that certain aspects of the disclosed processes can be arranged and combined in a wide variety of different configurations, all of which are contemplated herein.

### Experimental Results

A 500 mL aqueous solution comprising 10 g/l thiourea as complexing agent 214, 10 g/l of sulfamic acid as acid 222 and 5 g/l of NBS as oxidant 232 was prepared according to method 200. The pH of the resulting leaching solution 270 was maintained between approximately 1.5 and 2. The ORP of the resulting leaching solution 270 was maintained between approximately 180 mV and 240 mV.

Likewise, a 500 mL aqueous sodium cyanide solution comprising cyanide at 1 g/l was prepared.

Gold containing ore samples of 250 g with particle size of less than 150 μm were placed in a first beaker containing the 500 mL of the leaching solution prepared according to method 200 and in a second beaker containing the 500 ml of the aqueous sodium cyanide solution. The contents of the beakers were agitated continuously by a top mixer for five hours under ambient temperature and pressure conditions.

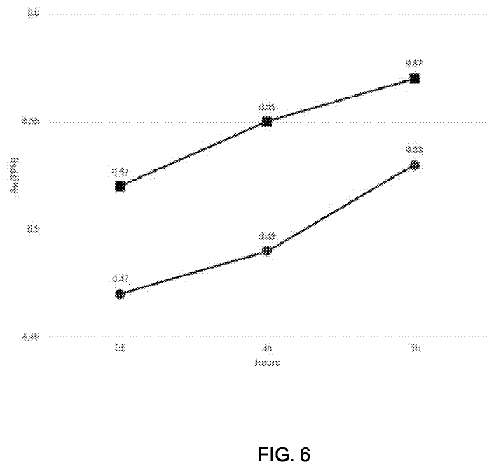

Samples were taken at 2.5 hours, 4 hours and 5 hours and assayed by atomic absorption spectrometry. As can be seen from FIG. 6, the leaching solution prepared according to method 200 (represented by the line with square markers) outperformed the sodium cyanide leaching solution (represented by the line with circular markers). At 2.5 hours, the leaching solution prepared according to method 200 contained 0.52 ppm gold while the sodium cyanide solution contained 0.47 ppm gold. At 4 hours, the leaching solution prepared according to method 200 contained 0.55 ppm gold while the sodium cyanide solution contained 0.49 ppm gold. At 5 hours, the leaching solution prepared according to method 200 contained 0.57 ppm gold while the sodium cyanide solution contained 0.53 ppm gold.

### Interpretation of Terms

Unless the context clearly requires otherwise, throughout the description and the “comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about” or “approximately”. In this context, “about” or “approximately” provides literal support for the exact numerical value that it precedes, the exact numerical value ±10%, as well as all other numerical values that are near to or approximately equal to that numerical value. Unless otherwise indicated a particular numerical value is included in “about” or “approximately” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.0 to 11.0; and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A mixture dissolvable in water to form a leaching solution for extracting metal from an ore, the mixture comprising:
a complexing agent, the complexing agent comprising thiourea;
an oxidant; and
an acid, the acid comprising sulfamic acid.

2. A mixture according to claim 1 wherein for every gram of complexing agent, the mixture comprises between approximately 0.05 grams and 20 grams of the acid.

3. A mixture according to claim 1 wherein for every gram of complexing agent, the mixture comprises between approximately 0.5 grams and 1.5 grams of the acid.

4. A mixture according claim 1 wherein the mixture comprises an oxidant, the oxidant comprising n-Bromosuccinimide (NBS).

5. A mixture according to claim 1 wherein the mixture comprises an oxidant, the oxidant comprising 1-Bromo-3-chloro-5,5-dimethylhydantoin (BCDMH).

6. A mixture according to claim 1 wherein for every gram of complexing agent, the mixture comprises between approximately 0.025 grams and 10 grams of the oxidant.

7. A mixture according to claim 1 wherein for every gram of complexing agent, the mixture comprises between approximately 0.25 grams and 0.75 grams of the oxidant.

8. A mixture according to claim 1 wherein for every gram of complexing agent, the mixture comprises between approximately:
0.67 grams and 1.5 grams of sulfamic acid; and
0.33 grams and 0.75 grams of NBS.

9. A mixture according to claim 1 wherein for every gram of complexing agent, the mixture comprises between approximately:
0.67 grams and 1.5 grams of sulfamic acid;
0.167 grams and 0.375 grams of n-Bromosuccinimide (NBS); and
0.167 grams and 0.375 grams of BCDMH.

10. A mixture according to claim 1 wherein for every gram of complexing agent, the mixture comprises between approximately:
0.67 grams and 1.5 grams of sulfamic acid; and
0.33 grams and 0.75 grams of BCDMH.

11. A mixture according to claim 1 wherein the mixture further comprises an ORP controller to increase oxidation-reduction potential (ORP).

12. A mixture according to claim 11 wherein the ORP controller comprises 2KHSO5·KHSO4·K2SO4.

13. A mixture according to claim 1 wherein the mixture further comprises a supplemental acid to reduce pH.

14. A mixture according to claim 1 wherein the mixture further comprises a stabilizer.

15. A mixture according to claim 14 wherein the stabilizer comprises ethylenediaminetetraacetic acid (EDTA).

16. A method of preparing a leaching solution, the method comprising:
forming a solution by:
dissolving a complexing agent in water, the complexing agent comprising thiourea;
dissolving an oxidant in the water; and
dissolving an acid in the water, the acid comprising sulfamic acid.

17. A leaching solution comprising:
water;
a complexing agent dissolved in the water, the complexing agent comprising thiourea;
an oxidant dissolved in the water; and
an acid dissolved in the water, the acid comprising sulfamic acid.

18. A method of extracting metal from an ore, the method comprising:
(a) preparing a leaching solution according to claim 16;
(b) contacting the leaching solution with the ore to dissolve the metal thereby forming a leachate; and
(c) separating the leachate from the ore.

19. A method according to claim 18 wherein the metal comprises gold or silver.

20. A method according to claim 18, the method further comprising (d) recycling the leachate after collecting the metal from the leachate to thereby produce recycled leaching solution.

21. A method according to claim 20 wherein step (d) comprises adjusting the oxidation-reduction potential (ORP) of the leachate by electrochemical oxidation to thereby produce the recycled leaching solution.

22. A method according to claim 21 wherein adjusting the ORP of the leachate by electrochemical oxidation comprises contacting the leachate with an anode and a cathode and applying a voltage across the anode and the cathode.
